(19) United States
(12) Patent Application Publication
(10) Pub. No.: US 2016/0328717 A1
(43) Pub. Date: Nov. 10, 2016

(54) BioWallet Biometrics Platform

(71) Applicant: AT&T Intellectual Property I, L.P., Atlanta, GA (US)

(72) Inventors: William Shaw, Kennesaw, GA (US); Brian M. Novack, St. Louis, MO (US); Rodney Brandenburgh, Acworth, GA (US); Mehmet Ozkan, Allen, TX (US); Tim Johnson, Eatonton, GA (US); Pramod Pateel, Suwanee, GA (US)

(73) Assignee: AT&T Intellectual Property I, L.P., Atlanta, GA (US)

(21) Appl. No.: 14/707,170

(22) Filed: May 8, 2015

(51) Int. Cl. G06Q 20/40; G06Q 20/36

(52) U.S. Cl. CPC G06Q 20/40145; G06Q 20/405; G06Q 20/363

(57) ABSTRACT

A method for facilitating a purchase using a biometric identifier includes receiving a biometric identifier and transaction information from a point of sale device. A user is then identified using the biometric identifier. It is then determined whether the user is authorized to complete a transaction identified by the transaction information. A payment request is transmitted to a financial institution server associated with the user in response to determining that the user is authorized to complete the transaction. An approval is transmitted to the point of sale device in response to receiving a payment request approval from the financial institution server. A customer copy of an electronic receipt is transmitted to a user device designated by the user and a merchant copy of the electronic receipt is transmitted to a merchant device designated by the merchant in order to provide both parties with a record of the transaction.

### BACKGROUND

The present disclosure relates generally to devices for facilitating transactions, and more particularly to payments using biometric authentication.

In-person purchases are typically paid for using cash, check, or credit cards. Thus, a person shopping for products and/or services has to remember to bring cash, a checkbook, and/or credit cards in order to pay for desired products and/or services. A person who forgets to bring a form of payment with them for a purchase may be inconvenienced by having to travel to retrieve a form of payment from its current location (e.g., the home or car of the person attempting to make a purchase). In addition, cash, checks, and credit cards can also be lost or stolen and then used fraudulently. Although checks and credit cards can be used to identify an authorized user, a person may not be able to determine if the person presenting a check or credit card is the same person identified by the check or credit card.

### SUMMARY

In one embodiment, a method for facilitating a purchase using a biometric identifier includes receiving a biometric identifier and transaction information from a point of sale device. A user is then identified using the biometric identifier. A user can be requested to provide additional authentication, such as a personal identification number. It is then determined whether the user is authorized to complete a transaction identified by the transaction information. A payment request is transmitted to a financial institution server associated with the user in response to determining that the user is authorized to complete the transaction. The payment request can include an identification of a financial instrument to be used in completing the transaction. An approval is transmitted to the point of sale device in response to receiving a payment request approval from the financial institution server. A customer copy of an electronic receipt is transmitted to a user device designated by the user and a merchant copy of the electronic receipt is transmitted to a merchant device designated by the merchant in order to provide both parties with a record of the transaction. The customer copy and the merchant copy can be transmitted via a medium selected by the user and the merchant, respectively. A user requesting to be enrolled in a biometric system for payment is requested to provide a biometric identifier and financial instrument such as a credit card or bank account information.

### BRIEF DESCRIPTION OF THE DRAWINGS

FIG. 1 depicts a system for facilitating purchases by a user via one or more biometric identifiers according to one embodiment;

FIG. 2 is a flowchart of a method for enrolling a user in the system of FIG. 1 according to one embodiment;

FIG. 3 is a flowchart of a method for a user to make purchases via the system of FIG. 1 using a biometric identifier; and

FIG. 4 depicts a high-level block diagram of a computer for implementing components of the system shown in FIG. 1.

### DETAILED DESCRIPTION

In one embodiment, purchases can be made by a user using one or more biometric identifiers as a primary authentication and one or more additional authentication factors. The biometric identifiers and the additional authentication factors as associated with a user and a user's financial instruments. A user can make a purchase using a point of sale device associated with a merchant using a biometric identifier, such as a fingerprint. The biometric identifier and transaction information is sent from the point of sale device to a user information and payment provider. The user information and payment provider identifies the user and the user's financial instruments based on the biometric identifier. The user information and payment provider determines if the transaction is authorized and, if so, contacts a financial institution server associated with a financial instrument of the user to determine if the financial institution authorizes the transaction. If the financial institution authorizes the transaction, the user information and payment provider transmits an indication that the transaction has been approved to the point of sale device. The user information and payment provider also transmits transaction information to the merchant and a user device associated with the user. No financial information is provided by the user to a point of sale device or merchant device to make a purchase. In one embodiment, a user can also provide personal information to third parties. In addition, a user does not have to carry a wallet, their financial instruments (such as credit/debit cards), identification (e.g. driver's license, social security card, etc.) and/or loyalty cards, or a device (such as a smart phone) containing data related to their financial instruments, identification cards, or loyalty cards.

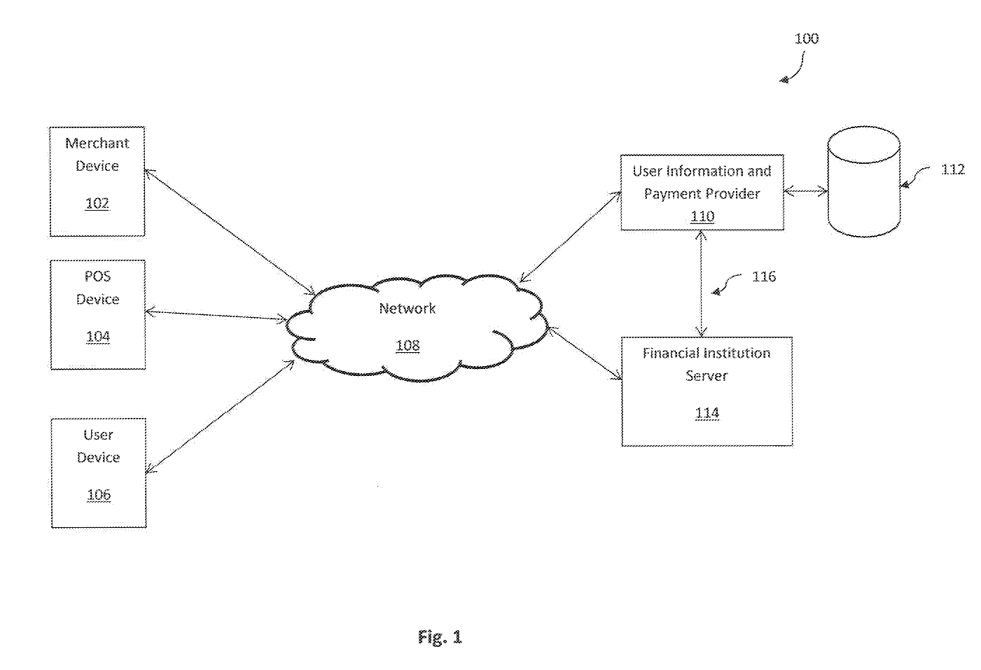

FIG. 1 depicts a system for facilitating purchases by a user via one or more biometric identifiers. In one embodiment, merchant device 102 is a device such as a computer (e.g., desktop computer, laptop computer, smart phone, etc.) which can acquire a biometric identifier (e.g., a fingerprint scanner) from a user and communicate with user information and payment provider 110. Merchant device 102 is in communication with user information and payment provider 110 via network 108. Merchant device 102, in one embodiment, is located at a merchant's location, such as a retail store and allows the merchant to accept payments using financial instruments such as checks or credit cards.

Point of sale (POS) device 104, in one embodiment, is a device such as a computer which can acquire a biometric identifier (e.g., a fingerprint scanner) from a user and communicate with user information and payment provider 110. POS device 104 is in communication with user information and payment provider 110 via network 108. POS device 104, in one embodiment, is part of a point of sale such as a vending machine or other automated purchasing and/or dispensing mechanism. POS device 104 can also be located in a business such as a retail store for use by a merchant in processing purchases.

In one embodiment, merchant device 102 is a computing device in communication with POS device 104 via network 108. In such embodiments, merchant device 102 can transmit transaction information to POS device 104 and POS device 104 can be used to receive user biometric identifier and authorize a purchase requested by the user.

User device 106, in one embodiment, is a device such as a computer (e.g., desktop computer, laptop computer, smart phone, etc.) which can acquire a biometric identifier (e.g., a fingerprint scanner) from a user and communicate with user information and user information and user information and payment provider 110. User device 106, in one embodiment, is located at a user's home or work. In other embodiments, user device 106 can be carried by a user.

User information and payment provider 110 (also referred to as payment provider 110), in one embodiment, is a computer capable of communicating with merchant device 102, POS device 104, user device 106, payment database 112, and financial institution server 110. In one embodiment, user information and payment provider 110 identifies a user based on one or more of the user's biometric identifiers and facilitates payment for a user's purchases.

User information and payment provider database 112 is in communication with user information and payment provider 110 and stores Information (e.g., tables including records) linking one or more users to their respective biometric identifiers and financial instruments. User information and payment provider database 112 is accessed by user information and payment provider 110 in order to identify a user based on biometric identifiers provided by the user as received from, for example, POS device 104 via network 108, to determine if a purchase by a user is authorized, and to identify one or more financial instruments that may be used to make a purchase by a user.

Financial institution server 114, in one embodiment, is a computer capable of communicating with merchant device 102, POS device 104, user device 106, and user information and payment provider 110 via network 108. In one embodiment, financial institution server 114 is associated with a specific bank or other institution and one or more financial instruments, such as checks or credit cards, assigned to a user. In one embodiment, financial institution server 114 and user information and payment provider 110 have a direct communication link 116 that does not require access via network 108 for security purposes.

Network 108 can be a wired or wireless network, or a combination of wired and wireless networks, capable of transmitting communications among merchant device 102, POS device 104, user device 106, user information and payment provider 110, and financial institution server 114.

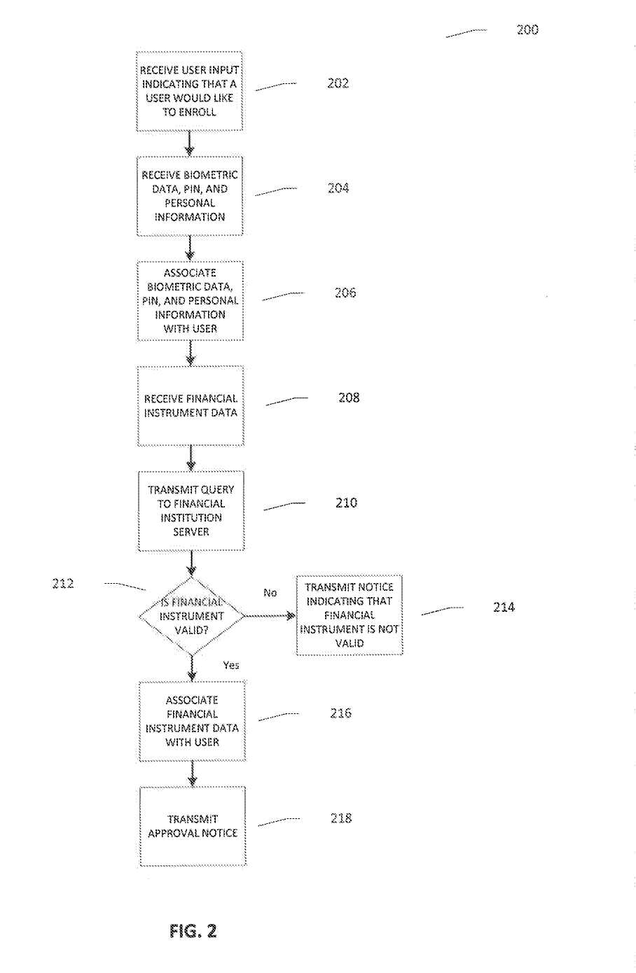

In one embodiment, a user must first enroll with the system prior to making purchases using the system. FIG. 2 depicts a flow chart of a method 200 for enrolling a user in system 100. At step 202, a user enters a request indicating that they would like to enroll. In this embodiment, the user enrolls via user device 106, which is a desktop computer having an input for scanning fingerprints. In other embodiments, a user can request to enroll via other devices such as merchant device 102 or POS device 104 or other types of user devices. The request to enroll is transmitted from user device 106 to user information and payment provider 110. In response to a user's request to enroll, user information and payment provider 110 transmits a request to user device 106 to prompt the user to enter their biometric information, personal identification number (PIN), and personal information. The user enters biometric data using a device such as a fingerprint scanner and personal information via an input such as a keyboard.

At step 204, the user's biometric data, a personal identification number, and personal information are transmitted from user device 106 and received by payment server 110 for processing. At step 206, the biometric data, personal identification number, and personal information are processed by user information and payment provider 110 by associating them with the user and storing them in a table in user information and payment provider database 112. The table allows a user to be identified using biometric data. In addition to identifying the user, the user's personal information, such as user demographics, user preferences, and prior purchase information can be retrieved from user's record in the table based on the biometric data.

After the biometric data and personal information are received and processed, user information and payment provider 110 transmits a request to user device 106 to obtain financial instrument data from the user. In response to the request, a user enters financial instrument data such as credit card information, checking account information, savings account information, etc. At step 208, financial instrument data entered by the user is transmitted from user device 106 and received by user information and payment provider 110. In response to receiving financial instrument data, at step 210 user information and payment provider 110 transmits a query to financial institution server 114 in order to determine if the financial instrument provided by the user is valid. At step 212, user information and payment provider 110 determines if the financial instrument provided by the user is valid based on an indication from financial institution server 114.

In one embodiment, user information and payment provider 110 is in communication with multiple financial institution servers. In such embodiments, the specific financial institution server queried is based on the financial institution associated with the financial instrument used. For example, if a financial instrument associated with Bank A is used, then a financial institution server associated with Bank A will be queried.

In response to the query, financial institution server 114 transmits an indication to user information and payment provider 110 indicating whether the financial instrument provided by the user is valid. In response to user information and payment provider 110 receiving an indication from financial institution server 116 that the financial instrument is not valid, the method proceeds to step 214 in which user information and payment provider transmits a notice to POS device 104 indicating that the financial instrument is not considered valid by financial institution server 116. In response to user information and payment provider 110 receiving an indication from financial institution server 114 that the financial instrument provided by the user is valid, the method proceeds to step 216 in which user information and payment provider 110 associates the financial instrument with the user by including financial instrument data in a record of table stored in user information and payment provider database 112. At step 218, user information and payment provider 110 transmits an approval notice to user device 106. User device 106 then displays an indication to the user that enrollment has been successfully completed. It should be noted that steps 208 through 218 can be repeated for multiple financial instruments.

It should be noted that a user can provide more than one financial instrument to user information and payment provider 110. In one embodiment, a user can select one of multiple financial instruments to be used as a default for purchases. Information indicating a default financial instrument to be used for purchases can be stored in a record associated with the user in user information and payment provider database 112. In one embodiment, if a financial instrument provided by a user is not indicated as being valid by financial institution server 114, user information and payment provider transmits a notice to user device 106 indicating that the financial instrument is not valid and requesting information for another financial instrument and/or corrected financial instrument information.

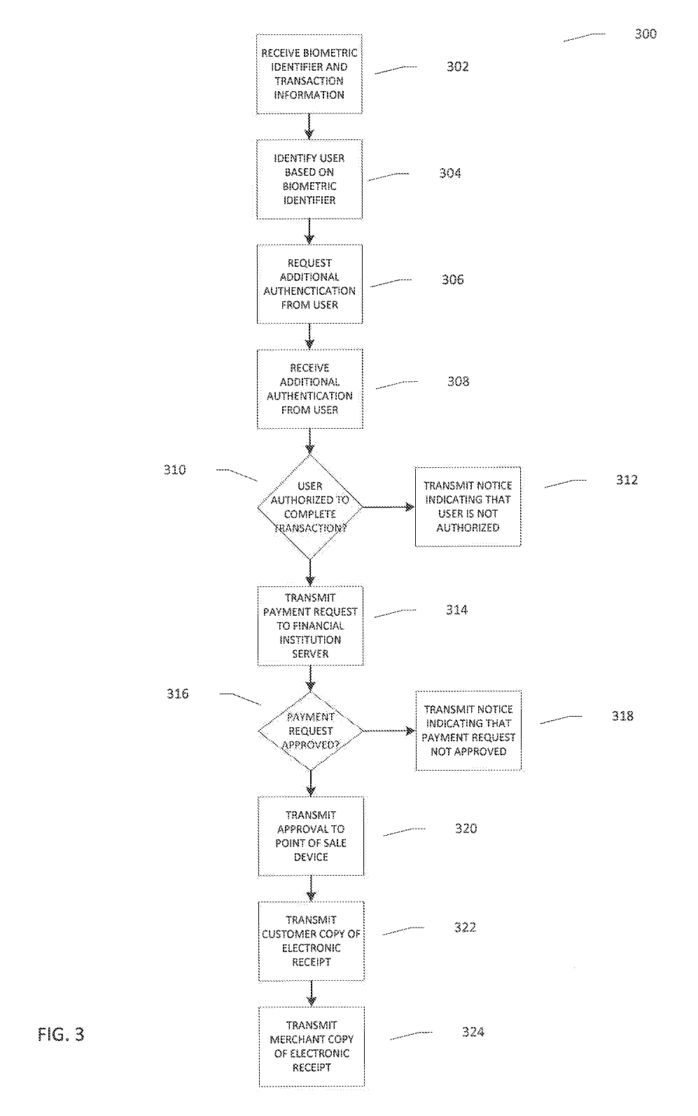

After enrollment, a user can utilize system 100 to make purchases using a biometric identifier in lieu of a financial instrument. FIG. 3 depicts a flowchart of a method 300 according to one embodiment in which a user makes a purchase from point of sale device 104 associated with a merchant using a biometric identifier. In one embodiment, a merchant enters a charge amount for a purchase by a user into point of sale device 104 associated with the merchant. For example, point of sale device 104 can be a credit card scanner including a fingerprint scanner and an interface for entering information manually, such as a keyboard or a keypad. The charge amount is displayed by point of sale device 104 to a user. A user then enters a biometric identifier, in this case a fingerprint, into point of sale device 104 via a fingerprint scanner.

At step 302, the user's biometric identifier and transaction information are transmitted from point of sale device 104 and received by user information and payment provider 110. At step 304, user information and payment provider 110 identifies the user based on the biometric identifier. In one embodiment, the user is identified by using the biometric identifier to locate a particular record associated with a user stored in user information and payment provider database 112. The record also contains financial instrument information associated with the user. At step 306, additional authentication is requested from the user via a message transmitted from user information and payment provider 110 to point of sale device 104. In response, the user enters additional authentication, such as a personal identification number (PIN), into point of sale device 104. At step 308, the PIN is transmitted from point of sale device 104 and received by user information and payment provider 110. It should be noted that additional authentication may not be requested in an embodiment. For example, if a biometric identifier provides a satisfactory level of security, additional authentication may not be required from a user.

At step 310, user information and payment provider 110 determines if the user is authorized to complete the transaction. In one embodiment, this determination is based on the user identification and verification of the additional authentication provided by the user. If the user is not authorized to complete the transaction, the method proceeds to step 312 and a notification is transmitted from user information and payment provider 110 to point of sale device 104 indicating that the user is not authorized to complete the transaction. In one embodiment, the determination of step 310 is based on an identity of the user and whether a valid financial instrument is associated with the identified user. In other embodiments, such as embodiments in which a child of a user is authorized to make purchases using the user's financial instrument, additional factors may be considered in determining whether the child is authorized to make a purchase. For example, a user may limit a child's purchases to specific days/times, certain types of purchases (e.g., a child may purchase books but not candy), an amount associated with a purchase, etc.

If user information and payment provider 110 determines that the user is authorized to complete the transaction, the method proceeds to step 314 in which user information and payment provider 110 transmits a payment request to financial institution server 114. In one embodiment, user information and payment provider transmits transaction information, including an identification of the user attempting the transaction and an amount of the transaction, to financial institution server 114. In addition, financial instrument information associated with the user, such as a credit card number, is retrieved from user information and payment provider database 112 and transmitted to financial institution server 114. Financial institution server 114 determines whether the user is authorized to complete the transaction and provides an indication of the determination to user information and payment provider 110. In one embodiment, financial institution server determines whether a user is authorized to make a purchase based on a credit limit associated with the financial instrument. In one embodiment, additional or alternative factors may be considered as well, such as user or financial institution designated constraints. For example, a user may be authorized to make purchases under a threshold amount and/or in certain locations as certain times.

At step 316, user information and payment provider 110 determines if the payment request is approved based on the indication received from financial institution server 114 in response to step 314. If the payment request is not approved, the method proceeds to step 318 in which user information and payment provider 110 transmits a notice to point of sale device 104 indicting that the payment request was not approved. If the payment request is approved, the method proceeds to step 320 in which user information and payment provider 110 transmits an approval notice the point of sale device 104. The approval notice, in one embodiment, includes an indication that the transaction is approved. User information and payment provider also stores transaction information in a record of the transaction table located in user information and payment provider database 112. At step 322, user information and payment provider 110 transmits a customer copy of an electronic receipt of the transaction to the user. In one embodiment, the customer copy of the electronic receipt is transmitted to a device of the user as designated by the user. For example, a customer copy of the electronic receipt can be sent to user device 106 in order to provide the user with a record of the transaction. At step 324, user information and payment provider 110 transmits a merchant copy of the electronic receipt to a merchant associated with point of sale device 104. For example, the merchant copy of the electronic receipt can be sent to merchant device 102 as designated by the merchant associated with point of sale device 104 in order to provide the merchant with a record of the transaction. The merchant can generate a hard copy of a receipt for the customer based on the merchant copy of the electronic receipt to provide the user with a record of the purchase.

Notifications indicating that a user is not authorized to complete a transaction, such as the notification of step 312, or that the payment request was not approved, such as the notification of step 318, may provide additional information indicating why a transaction was not approved. For example, a notification indicating that a payment request was not approved may also include information indicating why the payment request was not approved. This allows a user to attempt a transaction again in response to the notification. For example, a particular financial instrument to be used in making the purchase may not have available funds to complete the requested transaction. In response to the notification, a user can attempt the transaction again using a different financial instrument.

It should be noted that information pertaining to financial instruments of the user, such as credit card, checking account, and savings account numbers, are provided to user information and payment provider 110 by the user during enrollment only. A user who wants to make a purchase does not have to provide a merchant or point of sale device with financial instrument information. As such, the risk of having financial information exposed to various parties is reduced since the merchant or point of sale only obtains the user's biometric identifier and, in some cases, a personal identification number.

In one embodiment, a user can provide additional information, such as a user's personal information, identification card information (such as a user's driver's license number, social security number, etc.), information concerning a user's membership in a loyalty program, a user's preferences, etc. this additional information can be collected from the user in a manner similar to the method described herein pertaining to acquiring a user's financial instrument information. A user can also update their profile by changing information such as the user's personal information and financial instrument information.

It should be noted that various communications among devices such as merchant device 102, point of sale device 104, user device 106, user information and payment provider 110 and financial institution server 114 are encrypted. In one embodiment, encryption is used when communications include sensitive data such as a biometric identifier, financial instrument information, transaction information, personal identification numbers, etc. In one embodiment, all communications between devices are encrypted. In other embodiments, only some communications or portions of communications containing sensitive data can be encrypted.

In embodiments described above, a fingerprint is used as a biometric identifier. Other biometric identifiers may be used as well. For example, facial features, retinal features, iris features, voice, palm print, DNA, gait and other biometric features may be used in lieu of, or in addition to fingerprints. Depending on the type of biometric identifier to be used, devices such as merchant device 102, point of sale device 104, and user device 106 can include devices used to acquire biometric information.

In one embodiment, multiple users may be associated with a particular financial instrument. For example, a parent may allow a child to be associated with a particular financial instrument in order to allow the child to make purchases. In one embodiment, the parent may set certain restrictions that limit the use of the financial instrument by the child. For example, a parent may limit the amount of a purchase, the total amount of purchases over a period of time, the time and/or locations purchases may be made, etc.

Multiple transactions can be performed in response to a user providing a biometric identifier. For example, a first transaction requires a user to provide their biometric identifier. After the first transaction is completed, the user can be asked if they want to perform an additional transaction. The user can then perform one or more transactions after having entered their biometric identifier for the first transaction. The opportunity to perform an additional transaction may be limited to a predetermined time period in order to prevent someone other than the user requesting an additional transaction if the user who provided the biometric identifier leaves the area of the device which received the biometric identifier (e.g. the point of sale device).

In one embodiment, a user may select multiple financial instruments for one transaction. For example, a user may want to pay for half of a transaction using one financial instrument, such as a credit card, and pay for the other half of the transaction using a different financial instrument, such as a debit card. In one embodiment, the user is presented with an option to select which financial instrument(s) should be used for the transaction. A user can select a first financial instrument and an amount of the transaction that the first financial instrument should be used for. The user can then select a second financial instrument and an amount of the transaction that the second financial instrument should be used for. In one embodiment, more than two financial instruments can be used for a transaction.

In one embodiment, system 100 of FIG. 1 supports micropayments. A micropayment is a financial transaction involving a small amount of money (e.g., a transaction for less than one dollar). In one embodiment, user information and payment provider 110 tracks micropayments made by a user and completes a transaction for multiple micropayments after a specific total of micropayment amounts have been made. For example, user information and payment provider 110 can track micropayments made by a user and complete a single transaction for the total amount of micropayments after the total amount is greater than a specific amount (e.g., five dollars). In one embodiment, each micropayment is processed in the same manner as non-micropayment transactions as previously described.

With respect to loyalty programs, a user's purchases may be used to automatically inform a server associated with the loyalty program to be notified of the purchase so that the user's purchases can be tracked and rewarded as per loyalty program rules. For example, user information and payment provider 110 can communicate with a server associated with an entity responsible for the loyalty card and can transmit information concerning the loyalty cards.

In one embodiment, users can be authenticated to third parties by the third party contacting user information and payment provider 110. For example, a third party who wants to authenticate a user requests the user to provide a biometric identifier. The third party transmits the biometric identifier to user information and payment provider 110 which identifies the user using the biometric identifier. user information and payment provider 110 then transmits an identification of the user to the third party in response to the biometric identifier received from the third party. The third party can then determine if the user is who they claim to be. In one embodiment, the third party transmits a biometric identifier of a user and user identification, such as a user's name, to a user information and payment provider 110. User information and payment provider 110 can respond by confirming that the biometric identifier is associated with the user name provided by the third party. If the user name and biometric identifier do not correspond, user information and payment provider 110 transmits an indication to the third party that the biometric identifier does not correspond to the user name provided. Authentication can be used by third parties to allow users to access information, websites, containers, or physical locations based on whether the user is authenticated by system 100 of FIG. 1.

In one embodiment, third parties can be provided with a user's personal information using the user's biometric identifier. In response to a request for personal information, a user can provide a third party with their biometric identifier. The biometric identifier can then be transmitted by a device associated with the third party to user information and payment provider 110 with a request for user information. User information and payment provider 110 can retrieve user information and transmit the information to the third party. By providing user information from user information and payment provider 110, a user does not have to enter any of their personal information when requested by the third party. Since the user does not have to enter the information in response to the third party request, the information will not be stored in a cache locally by the third party and the information cannot be captured by, for example, a keystroke logger. In one embodiment, a request from a third party for a user's information can include one or more of a user's biometric identifier, an additional user identifier (e.g., the user's name), an identification of the third party, and a list of personal information the third party is requesting from the user information and payment provider 110. In response to a valid request, user information and payment provider 110 transmits the requested personal information to the third party. In one embodiment, the request and personal information transmitted can be encrypted and/or sent using tunneling techniques to prevent other parties from obtaining the user's information.

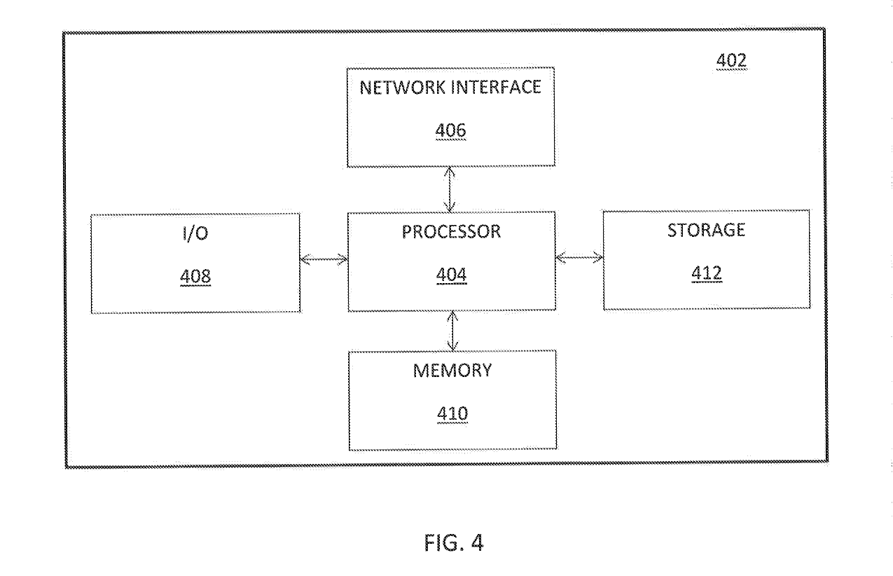

Merchant device 102, point of sale device 104, user device 106, user information and payment provider 110 and financial institution server 114 can each be implemented using a computer. A high-level block diagram of such a computer is illustrated in FIG. 4. Computer 402 contains a processor 404 which controls the overall operation of the computer 402 by executing computer program instructions which define such operation. The computer program instructions may be stored in a storage device 412, or other computer readable medium (e.g., magnetic disk, CD ROM, etc.), and loaded into memory 410 when execution of the computer program instructions is desired. Thus, the method steps of FIGS. 2 and 3 can be defined by the computer program instructions stored in the memory 410 and/or storage 412 and controlled by the processor 404 executing the computer program instructions. For example, the computer program instructions can be implemented as computer executable code programmed by one skilled in the art to perform an algorithm defined by the method steps of FIGS. 2 and 3. Accordingly, by executing the computer program instructions, the processor 404 executes an algorithm defined by the method steps of FIGS. 2 and 3. The computer 402 also includes one or more network interfaces 406 for communicating with other devices via a network. The computer 402 also includes input/output devices 1008 that enable user interaction with the computer 402 (e.g., display, keyboard, mouse, speakers, buttons, etc.) One skilled in the art will recognize that an implementation of an actual computer could contain other components as well, and that FIG. 10 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
receiving, by a user information and payment provider, a biometric identifier and transaction information from a point of sale device associated with a merchant;
identifying, by the user information and payment provider, a user based on the biometric identifier;
determining, by the user information and payment provider, whether the user is authorized to complete a transaction identified by the transaction information;
transmitting, by the user information and payment provider, a payment request to a financial institution server associated with the user in response to determining that the user is authorized to complete the transaction; and
transmitting, by the user information and payment provider, an approval to the point of sale device in response to receiving a payment request approval from the financial institution server.

2. The method of claim 1, wherein information pertaining to a particular financial instrument of the user is associated with the user and the payment request to the financial institution server comprises the information pertaining to the particular financial instrument of the user.

3. The method of claim 2, further comprising:
transmitting a customer copy of an electronic receipt to the user in response to receiving a payment request approval from the financial institution server; and
transmitting a merchant copy of the electronic receipt to the merchant associated with the point of sale device in response to receiving the payment request approval from the financial institution server.

4. The method of claim 1, further comprising:
receiving a personal identification number,
wherein the determining is based on the personal identification number matching a personal identification number associated with the user.

5. The method of claim 3, wherein the customer copy of the electronic receipt is transmitted to the user via a user designated medium and the merchant copy of the electronic receipt is transmitted to the merchant via a merchant designated medium.

6. The method of claim 1, wherein the transaction information is specified by a merchant associated with the point of sale device.

7. The method of claim 1, further comprising:
receiving an enrollment request from the user; and
enrolling the user by associating the user with the biometric identifier of the user and a financial instrument provided by the user.

8. An apparatus comprising:
a processor; and
a memory to store computer program instructions, the computer program instructions when executed on the processor cause the processor to perform operations comprising:
receiving a biometric identifier and transaction information from a point of sale device associated with a merchant;
identifying a user based on the biometric identifier;
determining whether the user is authorized to complete a transaction identified by the transaction information;
transmitting a payment request to a financial institution server associated with the user in response to determining that the user is authorized to complete the transaction; and
transmitting an approval to the point of sale device in response to receiving a payment request approval from the financial institution server.

9. The apparatus of claim 8, wherein information pertaining to a particular financial instrument of the user is associated with the user and the payment request to the financial institution server comprises the information pertaining to the particular financial instrument of the user.

10. The apparatus of claim 9, the operations further comprising:
transmitting a customer copy of an electronic receipt to the user in response to receiving a payment request approval from the financial institution server; and
transmitting a merchant copy of the electronic receipt to the merchant associated with the point of sale device in response to receiving the payment request approval from the financial institution server.

11. The apparatus of claim 8, the operations further comprising:
receiving a personal identification number,
wherein the determining is based on the personal identification number matching a personal identification number associated with the user.

12. The apparatus of claim 10, wherein the customer copy of the electronic receipt is transmitted to the user via a user designated medium and the merchant copy of the electronic receipt is transmitted to the merchant via a merchant designated medium.

13. The apparatus of claim 8, wherein the transaction information is specified by a merchant associated with the point of sale device.

14. The apparatus of claim 8, the operations further comprising:
further comprising:
receiving an enrollment request from the user; and
enrolling the user by associating the user with the biometric identifier of the user and a financial instrument provided by the user.

15. A computer readable medium storing computer program instructions, which, when executed on a processor, cause the processor to perform operations comprising:
receiving, by a user information and payment provider, a biometric identifier and transaction information from a point of sale device associated with a merchant;
identifying, by the user information and payment provider, a user based on the biometric identifier;
determining, by the user information and payment provider, whether the user is authorized to complete a transaction identified by the transaction information;
transmitting, by the user information and payment provider, a payment request to a financial institution server associated with the user in response to determining that the user is authorized to complete the transaction; and
transmitting, by the user information and payment provider, an approval to the point of sale device in response to receiving a payment request approval from the financial institution server.

16. The computer readable medium of claim 15, wherein information pertaining to a particular financial instrument of the user is associated with the user and the payment request to the financial institution server comprises the information pertaining to the particular financial instrument of the user.

17. The computer readable medium of claim 16, further comprising:
transmitting a customer copy of an electronic receipt to the user in response to receiving a payment request approval from the financial institution server; and
transmitting a merchant copy of the electronic receipt to the merchant associated with the point of sale device in response to receiving the payment request approval from the financial institution server.

18. The computer readable medium of claim 15, further comprising:
receiving a personal identification number,
wherein the determining is based on the personal identification number matching a personal identification number associated with the user.

19. The computer readable medium of claim 17, wherein the customer copy of the electronic receipt is transmitted to the user via a user designated medium and the merchant copy of the electronic receipt is transmitted to the merchant via a merchant designated medium.

20. The computer readable medium of claim 15, wherein the transaction information is specified by a merchant associated with the point of sale device.
